(19) United States
(12) Patent Application Publication
(10) Pub. No.: US 2009/0129716 A1
(43) Pub. Date: May 21, 2009

(54) Heat-Resistant, Oil Resistant Rolling Bearing and Rolling Bearing for Use in a Compressor of a Refrigerating Machine

(75) Inventors: Yosuke Oya, Mie (JP); Masaki Egami, Mie (JP)

Correspondence Address: WENDEROTH, LIND & PONACK, L.L.P., 1030 15th Street, N.W.,, Suite 400 East, Washington, DC, 20005-1503, US

(73) Assignee: NTN Corporation

(21) Appl. No.: 12/227,644

(22) PCT Filed: Jun. 29, 2007
(86) PCT No.: PCT/JP2007/063098

§ 371 Date: Nov. 24, 2008

(30) Foreign Application Priority Data
Jun. 30, 2006 (JP) 2006-180792
Jun. 26, 2007 (JP) 2007-167096

(51) Int. Cl. F16C 33/56

(52) U.S. Cl. 384/572

(57) ABSTRACT

An object is to provide a heat-resistant, oil-resistant rolling bearing which prevents release of low molecular weight polymers, additives and colorants that remain in trace amounts in the resin retainer from the resin body, thereby preventing deterioration of lubricating oil, and particularly a rolling bearing for use in a compressor of a refrigerating machine which prevents deterioration of refrigerating machine oil and which does not impair the function of capillary tubes of the refrigerating cycle.

A heat-resistant, oil-resistant rolling bearing is proposed which includes a retainer made of at least one crystalline resin selected from a polyamide resin (polyamide 4-6, polyamide 6T or polyamide 9T), polyphenylene sulfide and polyetherketone, and having a melting point of not less than 280° C. Because the retainer is made of a resin having the above predetermined melting point, the retainer withstands high temperatures less than the above predetermined melting point and prevents release of its resin components into liquid outside the bearing. Also, because the retainer is made of a crystalline resin, the retainer absorbs smaller amounts of liquids outside the retainer. This also serves to suppress separation of low molecular weight polymers, additives and colorants from the resin body.

### TECHNICAL FIELD

This invention relates to heat-resistant, oil-resistant rolling bearings, such as rolling bearings used in compressors of refrigerating machines, which are used under conditions where high heat resistance and oil resistance are required, and are typically brought into contact with refrigerating machine oil or refrigerant.

### BACKGROUND ART

The refrigeration cycle of a refrigerating machine serves as a heat pump for transferring heat from a low heat source to a high heat source by spending work. Specifically, during the refrigeration cycle, a refrigerant as a heat transfer medium is sucked into a compressor with machine oil mixed therein and compressed, and after oil separation, liquefied in a condenser by releasing heat. The refrigerant is then stored in a liquid receiver, expanded in an expansion valve due to the throttling effect into a low-temperature, low-pressure air-liquid mixture, is vaporized in an evaporator by absorbing heat from the environment, and again sucked into the compressor.

It is required that the compressor of such a refrigerating machine include heat-resistant, oil-resistant rolling bearings that can withstand contact with refrigerant containing machine oil. For the retainer of such a bearing, too, which retains rolling elements of the bearing, self-lubricity, chemical resistance and injection moldability are required. Also, in order to maximize the bearing life, many retainers are made of resin.

The retainers of some of known rolling bearings for use in compressors of refrigerating machines are made of such plastics as thermosetting resins, polyamide imide, polyetheretherketone, and polyphenylene sulfide (Patent document 1).

Patent document 1: JP patent publication 5-187355A

### DISCLOSURE OF THE INVENTION

### Object of the Invention

However, when such a conventional rolling bearing is mounted in a compressor of a refrigerating machine, and brought into contact with refrigerating machine oil and refrigerant under high-temperature, high-pressure conditions, low molecular weight polymers, additives and colorants that remain in trace amounts in the resin retainer tend to separate from the resin body, thereby deteriorating the refrigerating machine oil.

This problem arises not only in refrigerating machines but in other machines when the resin retainer of a rolling bearing is lubricated with oil at high temperature (especially in a closed-loop environment where oil is circulated or the bearing is placed in an oil bath). In such a case too, low molecular weight polymers, additives and colorants tend to deteriorate the durability of lubricating oil.

As the temperature rises, resin expands and absorbs oil. Also, low molecular weight substances and additives in the resin move actively and tend to move out of and separate from the resin. The thus separated substances deposit in oil in the form of suspended solids, which could become sludge that clogs capillary tubes of the refrigeration cycle.

An object of this invention is to provide a heat-resistant, oil-resistant rolling bearing which is free of the above problem and which prevents release of low molecular weight polymers, additives and colorants that remain in trace amounts in the resin retainer from the resin body, thereby preventing deterioration of lubricating oil, and particularly a rolling bearing for use in a compressor of a refrigerating machine which can prevent impurities from being mixed into refrigerating machine oil or refrigerant, thereby reducing sludge, which can clog capillary tubes of the refrigerating cycle.

### Means to Achieve the Object

In order to achieve this object, the present invention provides a heat-resistant, oil-resistant rolling bearing including a retainer made of a crystalline resin having a melting point of not less than 280° C.

Because the heat-resistant, oil-resistant rolling bearing according to this invention includes a retainer of a crystalline resin having a predetermined melting point or higher, the retainer withstands high temperatures less than its melting point, thus preventing resin components from being released into liquid outside the bearing. Also, because the retainer is made of a crystalline resin, the retainer absorbs smaller amounts of liquids outside the bearing. Due to these properties, low molecular weight polymers, additives and colorants are less likely to separate from the resin body or substrate. Thus, the heat-resistant, oil-resistant rolling bearing according to this invention is less likely to deteriorate lubricating oil and refrigerant.

The crystalline resin having a melting point of not less than 280° C. is preferably at least one resin selected from a polyamide resin, polyphenylene sulfide and polyetherketone. The polyamide resin is preferably one of polyamide 4-6, polyamide 6T and polyamide 9T.

This heat-resistant, oil resistant rolling bearing can be mounted in a compressor of a refrigerating machine and used in contact with refrigerating machine oil and refrigerant.

Because the retainer can withstand high temperatures to a certain degree, i.e. high temperatures lower than the above predetermined melting point, its resin components are not released into liquid outside the bearing. Also, because the retainer is made of a crystalline resin, the retainer absorbs smaller amounts of liquids outside the bearing. Due to these properties, low molecular weight polymers, additives and colorants are less likely to separate from the resin body. Thus, the heat-resistant, oil-resistant rolling bearing according to this invention is less likely to deteriorate lubricating oil and refrigerant, or to impair the function of the capillary tubes of the refrigeration cycle.

### ADVANTAGES OF THE INVENTION

Since the heat-resistant, oil-resistant rolling bearing according to this invention includes a retainer made of a crystalline resin having a melting point of not less than 280° C., low molecular weight polymers, additives and colorants that remain in trace amounts in the resin retainer do not separate from the resin body, so that the heat-resistant, oil-resistant rolling bearing according to this invention never deteriorates lubricating oil.

When the heat-resistant, oil resistant rolling bearing according to this invention is mounted in a compressor of a refrigerating machine and used in contact with refrigerating machine oil and refrigerant, it does not deteriorate the refrigerating machine oil, and never obstructs the function of capillary tubes in the refrigerating cycle.

### BEST MODE FOR EMBODYING THE INVENTION

The heat-resistant, oil-resistant rolling bearing according to this invention has a structure typical to ordinary bearings. That is, it typically comprises inner and outer races, rolling elements such as balls, rollers or needles that are disposed between the inner and outer races, and a retainer rotatably retaining the rolling elements in position.

The shape of the retainer is not particularly limited, and may be box-shaped, corrugated or block-shaped.

When this bearing is used in a compressor, the retainer has to be capable of not only withstanding high temperature (such as 140-150° C. as in the test mentioned below) and high pressures (such as 55 kgf/cm²=5.39 MPa as in the test mentioned below), but also maintaining chemical stability and required strength when brought into contact with various refrigerants. The retainer is formed, for example, by melting a crystalline resin having a melting point of not less than 280° C.

As is apparent from the below test results, the melting point of the crystalline resin forming the retainer should have a melting point of at least 280° C. The melting point may be e.g. within the range of 280 to 340° C., though its upper limit is much less important. Practically, if PEEK is used, the upper limit of the melting point is 334° C., so that the melting point is within the range of 280 to 334° C.

Specifically, the resin forming the retainer may be a polyamide resin, polyphenylene sulfide (hereinafter abbreviated to “PPS”), or polyetherketone. Specific polyamide resins having a melting point of not less than 280° C. include polyamide 4-6, polyamide 6T and polyamide 9T.

Polyamide 4-6, which is also called 46 nylon, is a crystalline resin produced by condensation copolymerization reaction between diaminobutane (carbon number 4) and adipic acid (carbon number 6), and has a melting point of 290° C. This resin has a glass transition temperature of 78° C., which is higher than that of 66 nylon, which is 66° C., and thus is considered to be sufficiently heat-resistant. Commercially available polyamide 4-6 includes Stanyl made by DSM (Netherlands).

Polyamide 6T, which is also called nylon 6T, is produced by condensation copolymerization between hexamethylenediamine (carbon number 6) and terephthalic acid, and has a melting point of 310 to 320° C. In order to improve formability, modified 6T produced by copolymerizing monomers may be used. Typical copolymerizing components include e.g. adipic acid. In this case, the glass transition temperature is 75 to 80° C. Commercially available polyamide 6T includes Arlen made by Mitsui Chemicals, Inc. and Amodel made by Amoco.

Polyamide 9T, which is also called 9T nylon, is a crystalline resin produced by condensation copolymerization between nonanediamine of which the repeating units of the polymer comprise a diamine having a carbon number of 9 and terephthalic acid. It crystallizes at high speed, and has a glass transition temperature of 75 to 80° C. Commercially available polyamide 9T includes Genesta made by Kuraray Co., Ltd.

PPS used in this invention comprises repeating units expressed by the Chemical Formula 1 below and typically comprises repeating units expressed by Chemical Formula 2. Such PPS has a glass transition temperature of 88° C. and a melting point of 285° C.

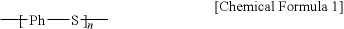

(In the formula, -Ph- is

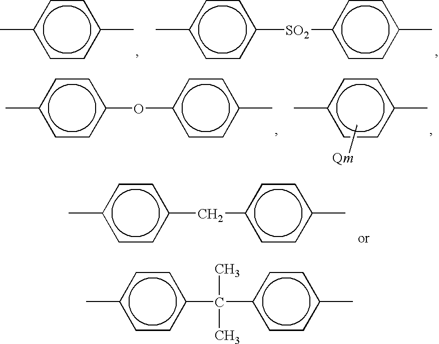

in which Q stands for a halogen of F, Cl or Br, or CH₃, and m stands for an integer 1, 2, 3 or 4.)

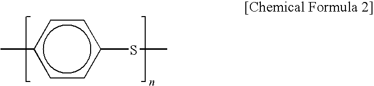

This resin is commercially available from Phillips Petroleum (USA) in the name of “Ryton” (trademark). Ryton is produced by reacting p-dichlorobenzene with sodium disulfide in a solvent of N-methyl pyrrolidone at 160 to 250° C. under pressure. In the post-heat treatment, the degree of polymerization of this resin can be freely adjusted from one having no cross-links at all in the resin to one having partial cross-linking. Its melt viscosity can be adjusted to a suitable level. PPS may have straight chains instead of cross-links. Also, a polymer alloy of PPS resin and polyamideimide resin may be used. Commercially available polymer alloys of this type include “AI Polymer” made by Mitsubishi Chemical Corporation.

Polyetherketone used in this invention is a resin in which aromatic rings are bonded together by ether groups and ketone groups, and includes wholly aromatic polyetherketone (PEK) and wholly aromatic polyetheretherketone (PEEK).

PEEK is preferable because it has excellent heat resistance, mechanical properties and self-lubricity, and also has a tensile elongation of 50%, which means that its plasticity is sufficiently high. Its glass transition temperature is 143° C. and its melting point is 334° C.

Typical repeating units in a polyetherketone usable in the present invention are shown in the Chemical Formula 3 below. But instead, another polyetherketone may be used in which the repeating units shown in Chemical Formula 3 are copolymerized with the repeating units shown in Chemical Formula 4.

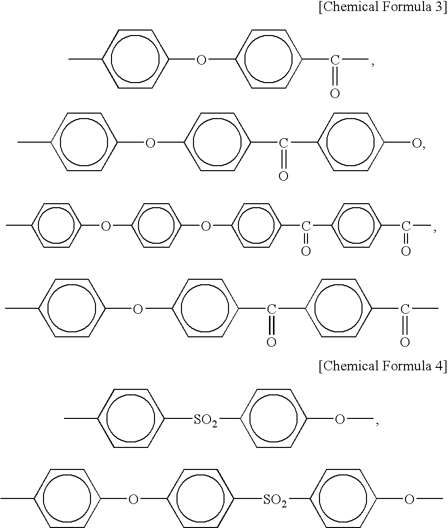

These polyether ketone resins are all crystalline resins. Among them, PEEK has a maximum crystallinity of as high as 48%. Commercially available polyetherketones usable in this invention include VICTREX-PEK 220G (made by Victrex), VICTREX-PEEK 150P, 380P and 450P, HOSTATEK (made by Hoechst), and ULTRA PEK-A1000 (made by BASF).

The material forming the retainer of the heat-resistant, oil-resistant rolling bearing according to this invention may contain inorganic additives such as carbon fiber, glass fiber, ceramic fiber, glass beads, glass balloon and mica, solid lubricants such as graphite, PTFE resin and molybdenum disulfide, metal antioxidants, stabilizers, colorants and other additives. Only one of them or more than one of them may be added. These additives may be subjected to surface treatment such as coupling treatment.

If reinforcing fibers are added to the resin, good results can be achieved when they are added by 5 to 30% by weight.

The rolling bearing according to this invention can be used in any type of compressor of a refrigerating machine, including reciprocating compressors (piston type and swash plate type), rotary compressors (rotary piston types, double-tooth or other rotary vane types, Roots types and scroll types), and (single- or twin-) screw compressors.

Refrigerating machine oils used in such refrigerating machines include mineral oil, polyol ester oil (POE) and polyalkylene glycol oil (PAG).

Refrigerants used in refrigerating machines include environmentally acceptable alternative Freon refrigerants, i.e. hydrofluorocarbon (HFC) refrigerants, and natural and non-Freon refrigerants, including ammonia, carbon dioxide, hydrocarbon, water, and any other known refrigerant. Typical refrigerants include R134a (HFC refrigerant) and R600a (isobutene; HC refrigerant).

### EXAMPLES

### Examples 1-5 of the invention and Comparative Examples 1 and 2

Retainers of rolling bearings were formed of compositions comprising resins and additives shown in Table 1. Bearings obtained were subjected to (I) a high-temperature immersion test and (II) a high-temperature, high-pressure immersion test. The test results are also shown in Table 1.

In order to achieve predetermined strength, reinforcing fibers were added to the resins forming the retainers of the respective rolling bearings. Care was taken so that the amounts of fibers added to the respective resins were as close to each other as possible. In particular, the content of reinforcing fibers in the polyamide resin forming the retainer was 25%. The material forming each retainer was basically a commercially available material. But polyamide 6T was made of a composition comprising Arlen A315 and A335 (made by Mitsui Chemicals, Inc.), which are glass fiber (GF) reinforced grades (GF contents: 15% and 35%, respectively), and which were added in the ratio of 50:50. Thus, the total content of reinforcing fibers was 25%.

[Test (I): High-Temperature Immersion Test]

The retainers of Examples 1-5 of the invention and Comparative Examples 1 and 2 were immersed in colorless refrigerating machine oil comprising POE oil (Kaolube 268 made by Kao Corporation) for 48 hours, during which the oil was kept at 140° C. Thereafter, the oil was observed by the naked eye to check whether the oil had been colored and for any suspended solids in the oil. The organic additives and copper additives contained in the materials of Comparative Examples 1 and 2 are all oil-insoluble, so that they never dissolve or are never released into oil.

[Test (II): High-Temperature, High-Pressure Immersion Test]

Test pieces were formed of the same materials forming the retainers of Examples 1-5 of the invention and Comparative Examples 1 and 2 (UL-Standard 94 [12.7×127×3.2 mm]). Simulating the use condition of rolling bearings mounted in a compressor of a refrigerating machine, the test pieces were immersed in a mixture of 50% refrigerating machine oil comprising colorless POE oil (Kaolube 268 made by Kao Corporation) and 50% R134a made by DuPont as a refrigerant under heated and pressurized conditions, i.e. at 150° C. and at a sealed pressure of 5.39 MPa (=55 kgf/cm²) for 72 hours. Thereafter, the oil was observed by the naked eye to check whether the oil had been colored and for any suspended solids in the oil.

TABLE 1

| | | Example number | | | | | | |
|---|---|---|---|---|---|---|---|---|
| | | Examples of the invention | | | | | Comparative Examples | |
| Material and test | | 1 | 2 | 3 | 4 | 5 | 1 | 2 |
| Material | | PA46 + | PA6T + | PA9T + | PPS + | PEEK + | PA66 + | PA66 + |
| | | GF25% | GF25% | GF25% | GF40% | GF30% | GF25% | GF25% |
| | | | | | | | (Organic | (Copper |
| | | | | | | | additive) | additive) |
| Melting point (° C.) | | 295 | 310 to | 304 | 285 | 334 | 260 | 260 |
| | | | 320 | | | | | |
| Test (I) | Coloring of oil | No | No | No | No | No | Yes | Yes |
| high temp | Suspension in | No | No | No | No | No | Yes | Yes |
| (Test | oil | | | | | | | |
| specimen: | | | | | | | | |
| retainer) | | | | | | | | |
| Test (II) | Coloring of oil | No | No | No | No | No | Yes | Yes |
| high-temp | and | | | | | | | |
| high-pressure | refrigerant | | | | | | | |
| (Test | Suspension in | No | No | No | No | No | Yes | Yes |
| specimen: UL | oil-refrigerant | | | | | | | |
| test piece | mixture | | | | | | | |

As is apparent from the results of Table 1, it was visually confirmed that the refrigerating machine oil (Test I) and the mixture of refrigerating machine oil and refrigerant (Test II) in which each of Comparative Examples 1 and 2, which is made of a resin having a melting point below 280° C. (i.e. 260° C.), was immersed had been colored, and suspended solids were observed too. But for the refrigerating machine oil and the mixture of refrigerating oil and refrigerant in which each of Examples 1 to 5 of the invention, which is made of a crystalline resin having a melting point of at least 280° C. (i.e. 280 to 334° C.), was immersed, neither coloring nor suspended solids were observed at all.

These test results indicate that when a resin retainer made of a crystalline resin having a melting point of not less than 280° C. is used in an environment where the retainer is brought into contact with refrigerating machine oil and refrigerant under pressurized and heated conditions, low molecular weight polymers, additives and colorants that remain in trace amounts in the retainer never separates from the resin body into the refrigerating machine oil and refrigerant, thus preventing deterioration of refrigerating machine oil as a lubricating oil or a mixture of refrigerating machine oil and refrigerant.

1. A heat-resistant, oil-resistant rolling bearing including a retainer comprising a crystalline resin having a melting point of not less than 280° C.

2. The heat-resistant, oil-resistant rolling bearing of claim 1 wherein said crystalline resin has a melting point of 280 to 340° C.

3. The heat-resistant, oil-resistant rolling bearing of claim 1 wherein said crystalline resin is at least one resin selected from a polyamide resin, polyphenylene sulfide and polyetherketone.

4. The heat-resistant, oil-resistant rolling bearing of claim 3 wherein said polyamide resin is one of polyamide 4-6, polyamide 6T and polyamide 9T.

5. The heat-resistant, oil resistant rolling bearing of claim 1, which is mounted in a compressor of a refrigerating machine and used in contact with refrigerating machine oil and refrigerant.

6. The heat-resistant, oil resistant rolling bearing of claim 2, which is mounted in a compressor of a refrigerating machine and used in contact with refrigerating machine oil and refrigerant.

7. The heat-resistant, oil resistant rolling bearing of claim 3, which is mounted in a compressor of a refrigerating machine and used in contact with refrigerating machine oil and refrigerant.

8. The heat-resistant, oil resistant rolling bearing of claim 4, which is mounted in a compressor of a refrigerating machine and used in contact with refrigerating machine oil and refrigerant.
